(19) United States
(12) Patent Application Publication
(10) Pub. No.: US 2012/0023307 A1
(43) Pub. Date: Jan. 26, 2012

(54) METHODS, SYSTEMS, AND COMPUTER PROGRAM PRODUCTS FOR EXCLUDING AN ADDRESSABLE ENTITY FROM A TRANSLATION OF SOURCE CODE

(76) Inventor: Robert Paul Morris, Raleigh, NC (US)

(21) Appl. No.: 12/842,960

(22) Filed: Jul. 23, 2010

(51) Int. Cl. G06F 12/10

(52) U.S. Cl. 711/206; 711/E12.061

(57) ABSTRACT

Methods and systems are described for excluding an addressable entity from a translation of source code. A first translation is received that is translated from source code including a first addressable entity specified in a programming language and that includes a first translation of the first addressable entity. Excluding information is received that identifies the first translation of the first addressable entity as excludable from a second translation, of the source code, translated from the first translation. Translation configuration information is received for translating the first translation. In response to the translation configuration information being received, the first translation is translated into the second translation excluding, based on the excluding information, the first addressable entity.

### RELATED APPLICATIONS

This application is related to the following commonly owned U.S. Patent Application, the entire disclosure being incorporated by reference herein: application Ser. No. ______, (Docket No. 0156) filed on Jul. 23, 2010, entitled “Methods, Systems, and Program Products for Processing an Excludable Addressable Entity”.

### BACKGROUND

Many programmers include extra source code in programs to perform functions unrelated to the function(s) provided for users of the programs. For example, code for debugging, code for performance profiling, and even code for technical support after a program has been delivered to a user in often included. Further code for error detection and checks for program correctness are often included. It is not unusual for the extra source code to be longer than the source code for the user function(s). An application, code library, and/or other executable generated from source code written in a programming language is typically delivered to a user without removing extra code. In many cases, this extra code may never be executed when the executable is processed by a device of the user. For example, tracing and/or logging code for debugging may never or may rarely be activated.

Some or all of this extra code may be included in-line in an executable so that it is loaded into a processor memory every time the executable is loaded. Further, some of this extra code includes code to determine whether the extra code should be executed. Programmers rarely have time at the end of a development cycle to remove this extra code and often fear that removing the code may introduce new “bugs” into the software, so it is left in the source code and translated into the object code, script code, byte code, and/or machine code to deliver to a user.

Macro languages are sometimes used to include and/or exclude source code prior to translating or compiling the source code into another representation, such as object code. This technique does not allow code to be included in an executable when needed by a customer without either providing the source code to the customer or providing multiple versions of the executable with various portions of extra code in the various versions to load and execute as needed.

Most programs are delivered to users as translations represented as object code, byte code, and the like. When a file including object code or byte code is translated into a machine code translation in a processor memory for execution, users have little or no control over which addressable entities in the object code and/or byte code translations are loaded into executable machine code translations. Excluding an addressable entity from a program component is currently performed by programmers during development, leaving little or no control for users and administrators.

Accordingly, there exists a need for methods, systems, and computer program products for excluding an addressable entity from a translation of source code.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In another aspect, a method for excluding an addressable entity from a translation of source code is described that includes receiving a first translation, translated from source code including a first addressable entity specified in a programming language, including a first translation of the first addressable entity. The method further includes detecting excluding information identifying the first translation of the first addressable entity as excludable from a second translation, of the source code, translated from the first translation. The method still further includes receiving translation configuration information for translating the first translation. The method also includes translating, in response to receiving the translation configuration information, the first translation into the second translation excluding, based on the excluding information, the first addressable entity.

Still further, a system for excluding an addressable entity from a translation of source code is described. The system includes an execution environment including an instruction processing unit configured to process an instruction included in at least one of a translation director component, an exclusion manager component, a configuration access component, and a translation engine component. The system includes the translation director component configured for receiving a first translation, translated from source code including a first addressable entity specified in a programming language, including a first translation of the first addressable entity. The system further includes the exclusion manager component configured for detecting excluding information identifying the first translation of the first addressable entity as excludable from a second translation, of the source code, translated from the first translation. The system still further includes the configuration access component configured for receiving translation configuration information for translating the first translation. The system also includes the translation engine component configured for translating, in response to receiving the translation configuration information, the first translation into the second translation excluding, based on the excluding information, the first addressable entity.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for processing an excludable addressable entity according to an aspect of the subject matter described herein;

FIG. 3 is a block diagram illustrating an arrangement of components for processing an excludable addressable entity according to another aspect of the subject matter described herein;

FIG. 4 is a block diagram illustrating an arrangement of components for processing an excludable addressable entity according to another aspect of the subject matter described herein;

FIG. 5 is a flow diagram illustrating a method for excluding an addressable entity from a translation of source code according to another aspect of the subject matter described herein;

FIG. 6 is a block diagram illustrating an arrangement of components for excluding an addressable entity from a translation of source code according to another aspect of the subject matter described herein;

FIG. 7 is a block diagram illustrating an arrangement of components for excluding an addressable entity from a translation of source code according to another aspect of the subject matter described herein;

FIG. 8 illustrates source code according to another aspect of the subject matter described herein;

FIG. 9 illustrates source code according to another aspect of the subject matter described herein; and

FIG. 10 illustrates source code according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art that one or more aspects of the disclosure may be practiced with a lesser degree of these specific details. In other instances, well-known structures and devices are shown in block diagram form in order to facilitate describing one or more aspects of the disclosure.

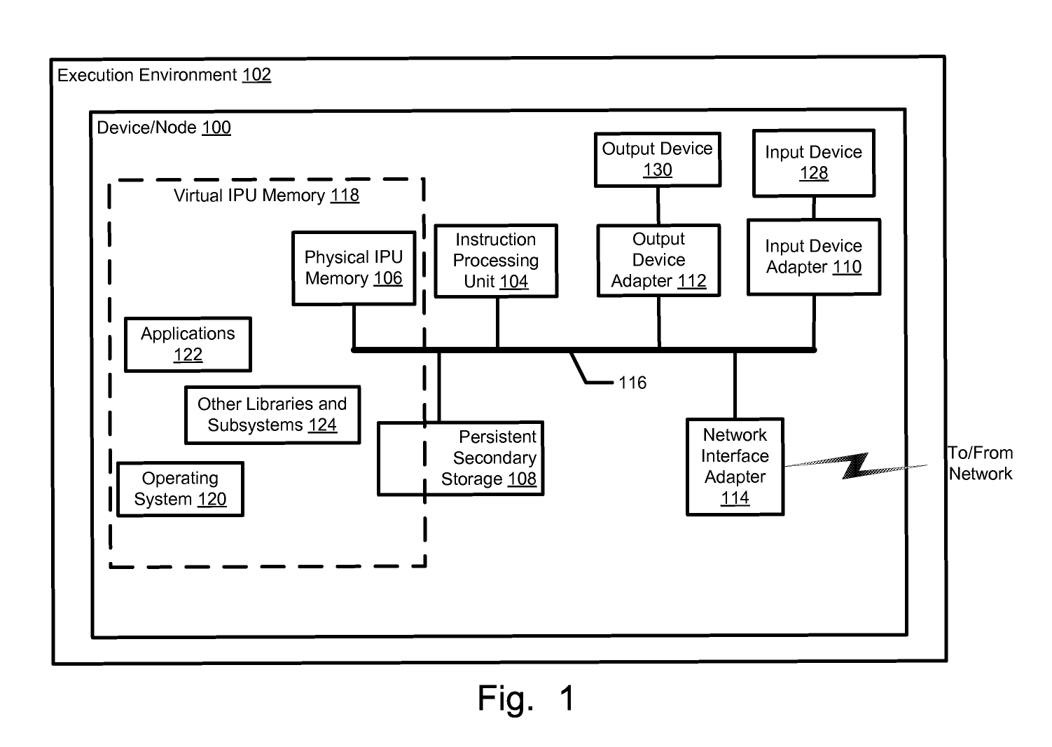

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in or otherwise providing suitable execution environments for configuring according to the subject matter include personal computers, notebook computers, tablet computers, servers, handheld and other mobile devices, multiprocessor devices, distributed devices, consumer electronic devices, routers, communication servers, and/or other network-enabled devices. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical processor memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display or audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual processor memory 118 spanning at least part of physical processor memory 106 and at least part of persistent secondary storage 108. Virtual processor memory addresses in a memory address space may be mapped to physical memory addresses identifying locations in physical processor memory 106. An address space for identifying locations in a virtual processor memory is referred to as a virtual processor memory address space; its addresses are referred to as virtual processor memory addresses; and its processor memory is known as a virtual processor memory or virtual memory. The term “processor memory” may refer to physical processor memory 106 and/or virtual processor memory 118 depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include removable media. The drives and their associated computer readable storage media provide volatile and/or nonvolatile storage for computer readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessible to IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a computing context referred to as a “process”. A process may include one or more “threads”. A “thread” includes a sequence of instructions executed by IPU 104 in a computing sub-context of a process. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical processor memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user.

A device included in or otherwise providing an execution environment may operate in a networked environment communicating with one or more devices via one or more network interface components. The terms “communication interface component” and “network interface component” are used interchangeably. FIG. 1 illustrates network interface adapter (NIA) 114 as a network interface component included in execution environment 102 to operatively couple device 100 to a network. A network interface component includes a network interface hardware (NIH) component and optionally a software component. The terms “network node” and “node” in this document both refer to a device having a network interface component for operatively coupling the device to a network.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “device” and “node” as used herein refer to one or more devices and/or nodes, respectively, providing and/or otherwise included in an execution environment unless clearly indicated otherwise.

As used herein, the terms “program” and “executable” refer to any data representation that may be translated into a set of machine code instructions and optionally associated program data. Thus, a program or executable may include an application, a shared or non-shared library, and a system command. Program representations other than machine code include object code, byte code, and source code.

Programs are represented or specified according to a “language”. A “programming language” is defined for expressing data and instructions by a programmer for executing by an IPU in an execution environment. A programming language defines syntax defining a format and/or a vocabulary for determining whether a source code is valid according to the programming language. A programming language defines the semantics or meaning of source code written in the programming language with respect to an execution environment in which a translation of the source code is executed. Source code written in a programming language may be translated into a “representation language”. As used herein, a “representation language” specifies at least one of a syntax and a vocabulary for a target translation of source code that maintains the functional semantics expressed in the source language with the exception of any excluded addressable entities according to the subject matter described herein. Note that some programming languages may serve as representation languages.

Exemplary types of programming languages for programmers include array languages, object-oriented languages, aspect-oriented languages, assembler languages, command line interface languages, functional languages, list-based languages, procedural languages, reflective languages, scripting languages, and stack-based languages. Exemplary programming languages include C, C#, C++, FORTRAN, COBOL, LISP, FP, JAVA®, APL, PL/I, ADA, Smalltalk, Prolog, BASIC, ALGOL, ECMAScript, BASH, and various assembler languages. Exemplary types of representation languages include object code languages, byte code languages, machine code languages, programming languages, and various other translations of source code.

A “compiler”, also referred to as a “translator”, as used herein is a component or an arrangement of components that translates source code written in a source language or a translation of the source code into a target translation of the source code expressed according to a representation language. A translator may translate a first translation of source code into a second translation of source code. A translation received as input to a translator is referred to herein as a “source translation” or an “input translation” and a translation generated by a translator is referred to herein as a “target translation” or an “output translation”. The term “source code” as used herein refers to computer code written in a programming language. For example, source code is often written by a programmer as an original work.

According to an aspect of the subject matter described herein, some of the function of the source code may be identified for excluding from a translation of the source code. According to another aspect of the subject matter described herein, some of the function of the source code may be excluded from a translation of the source code. A translation of source code is functionally equivalent to the source code or to the portion of the source code not excluded. The terms “compiling” and “translating” are used interchangeably herein. Both terms refer to the operation of a compiler or translator in translating source code and/or a translation of source code into a target translation. Linkers and loaders may operate as translators as the term “translator” is used herein.

Some source code includes one or more macros written in a macro language. Macro languages are not programming languages and are thus preprocessed rather than “compiled” or “translated” as the terms are defined herein.

As used herein, an “addressable entity” is a portion of a program, specifiable in a programming language in source code. An addressable entity is addressable in a program component translated from the source code in a compatible execution environment. Examples of addressable entities include variables, constants, functions, subroutines, procedures, modules, methods, classes, objects, code blocks, and labeled instructions. A code block includes one or more instructions in a given scope specified in a programming language. An addressable entity may include a value. In some places in this document “addressable entity” refers to a value of an addressable entity. In these cases, the context will clearly indicate that the value is being referenced.

Addressable entities may be written in and/or translated to a number of different programming languages and/or representation languages, respectively. An addressable entity may be specified in and/or translated into source code, object code, machine code, byte code, and/or any intermediate languages for processing by an interpreter, compiler, linker, loader, or analogous tool.

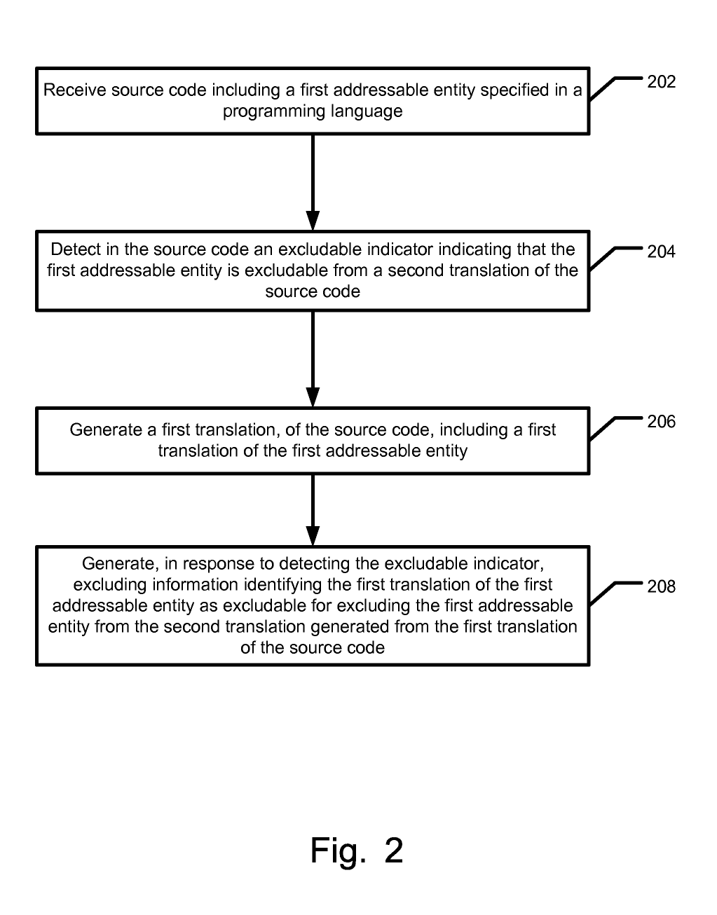

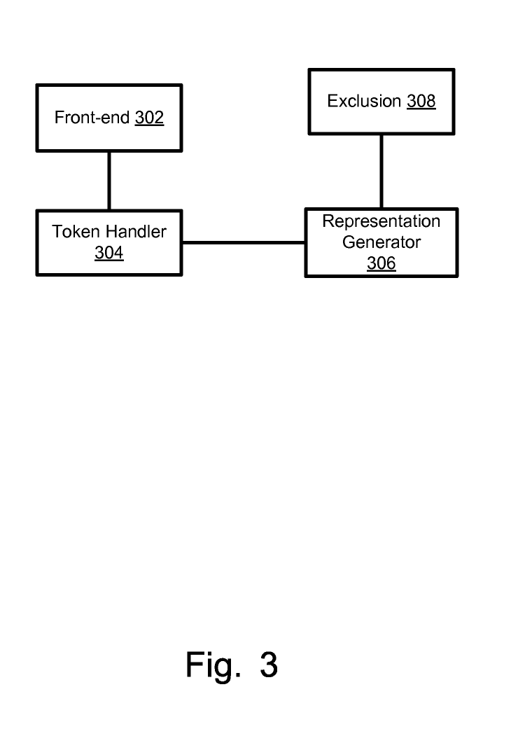

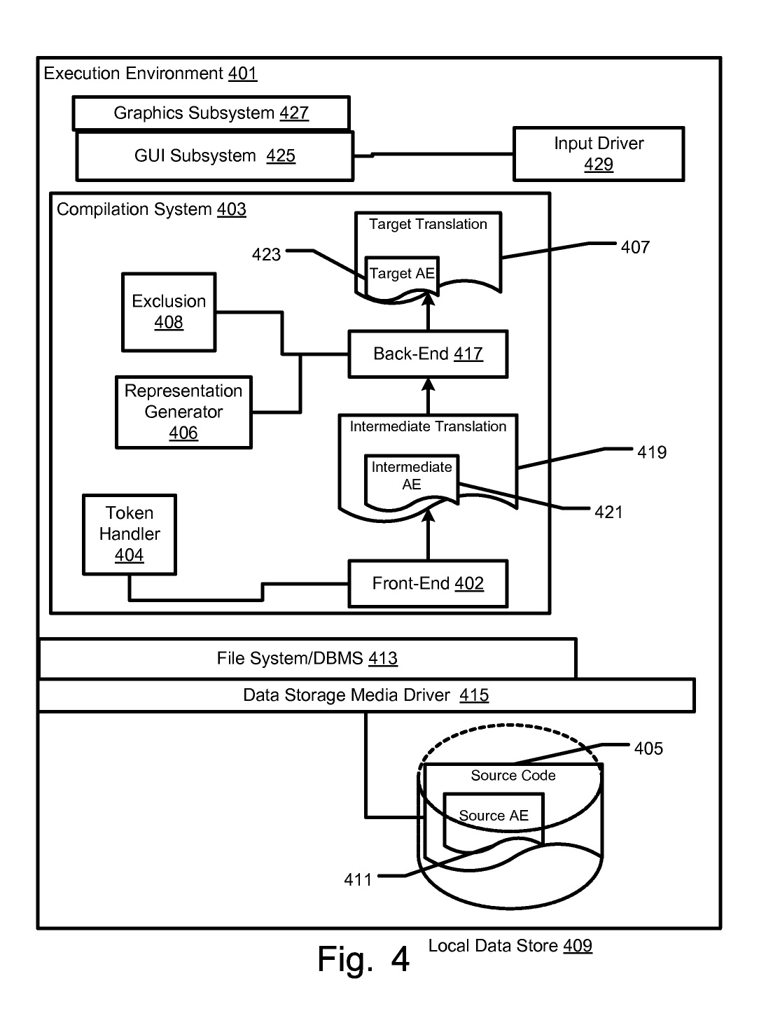

The block diagram in FIG. 3 illustrates an exemplary system for processing an excludable addressable entity according to the method illustrated in FIG. 2. A system for performing the method illustrated in FIG. 2 includes an execution environment, including an instruction-processing unit, configured to process an instruction included in at least one of a front-end component 302, a token handler component 304, a representation generator component 306, and an exclusion component 308 illustrated in FIG. 3. Some or all of the exemplary components illustrated in FIG. 3 may be adapted for performing the method illustrated in FIG. 2 in a number of execution environments. FIG. 4 is a block diagram illustrating the components of FIG. 3 and/or analogs of the components of FIG. 3 adapted for operation in execution environment 401 including or otherwise provided by one or more nodes.

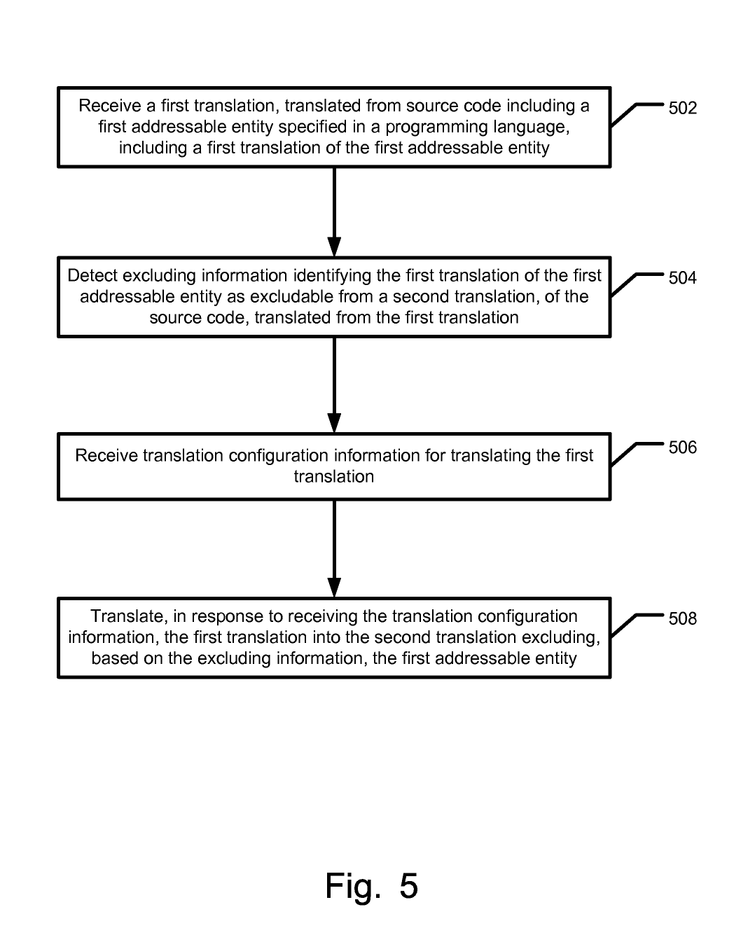

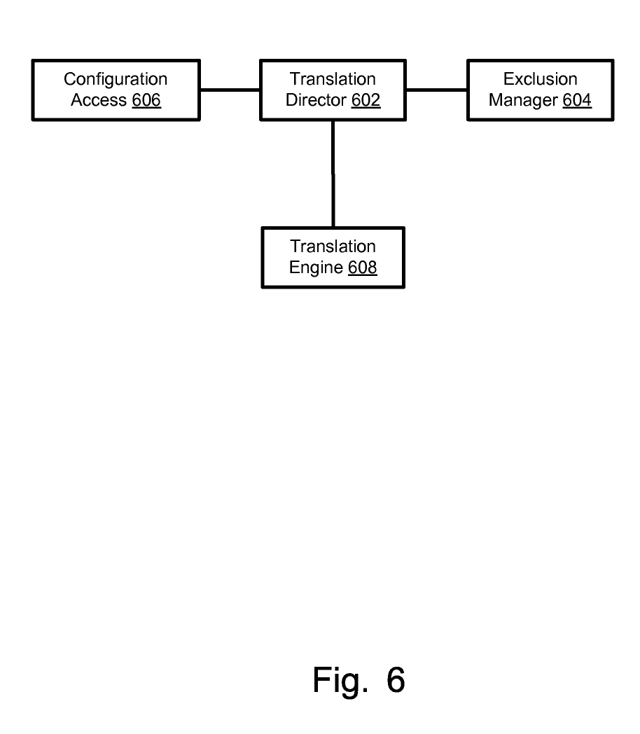

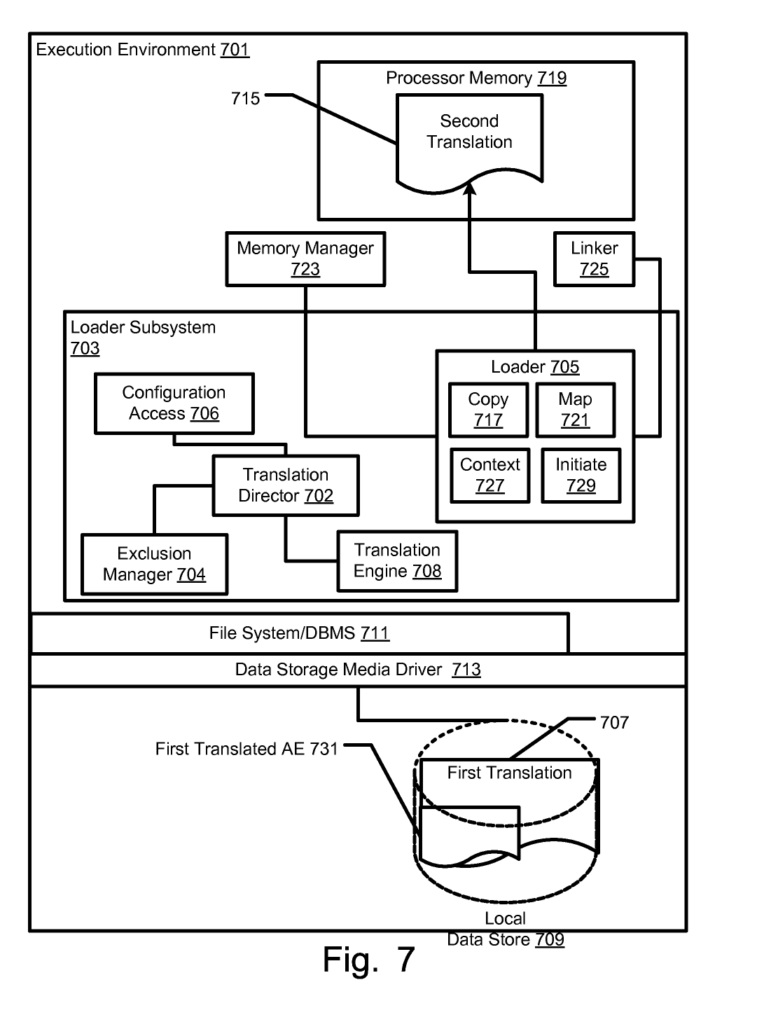

The block diagram in FIG. 6 illustrates an exemplary system for excluding an addressable entity from a translation of source code according to the method illustrated in FIG. 5. A system for performing the method illustrated in FIG. 5 includes an execution environment, including an instruction-processing unit, configured to process an instruction in at least one of a translation director component 602, an exclusion manager component 604, a configuration access component 606, and a translation engine component 608 illustrated in FIG. 6. Some or all of the exemplary components illustrated in FIG. 6 may be adapted for performing the method illustrated in FIG. 5 in a number of execution environments. FIG. 7 is a block diagram illustrating the components of FIG. 6 and/or analogs of the components of FIG. 6 adapted for operation in execution environment 701 including or otherwise provided by one or more nodes.

FIG. 1 illustrates components of an exemplary device that may at least partially provide and/or otherwise be included in an execution environment. The components illustrated in FIG. 4 and FIG. 7 may be included in or otherwise combined with the components of FIG. 1 to create a variety of arrangements of components according to the subject matter described herein.

FIG. 4 illustrates execution environment 401 hosting a compilation system 403 for translating and/or otherwise transforming source code 405 written in a programming language into a target translation 407. FIG. 4 illustrates compilation system 403 including an adaptation of the arrangement of components in FIG. 3.

FIG. 4 illustrates front-end component 402 included in compilation system 403. Front-end component 402 may receive source code 405 from a data store, from a user via an input device, and/or via a network from another execution environment including and/or provided by one or more nodes. Front-end component 402 may receive source code 405 from a variety of types of data stores storing data in various types of data storage media. FIG. 4 illustrates source code 405 stored in local data store 409. Source code 405 includes source code written in a programming language specifying an addressable entity, illustrated as source addressable entity (AE) 411, and may include other addressable entities. In an aspect, front-end component 402 may receive source code 405 stored in a file accessible via file system 413. File system 413 may access a data storage medium or media in local data store 409 via data storage media driver 415.

In various aspects, components in compilation system 403 may make one or more passes over source code 405 and/or translations of source code produced during translation of source code 405 to target translation 407. Whether a compilation system 403 operates in a single pass or in multiple passes depends on the requirements of a programming language and decisions of those who build the compilation system.

Compilation system 403 illustrates a compiler or translator structured to operate in phases or layers. FIG. 4 illustrates back-end component 417 included in compilation system 403 to perform one or more phases in addition to the phase(s) performed by front-end component 402. One or more middle-end components may be included in and/or otherwise accessed by compilation system 403 to perform optional operations such as various optimizations. In an aspect, an adaptation and/or analog of the arrangement of components in FIG. 3 may be included in one or more middle-end components (not shown). A phase, when performed, may produce a translation of source code 405. The division of phases and thus the component structure of a compilation system may vary according to the requirements of a programming language and decisions of those who build the compilation system.

Front-end component 402 may determine whether source code 405 is valid according to the programming language of source code 405. Front-end component 402 may verify that source code 405 is syntactically and/or semantically correct according to the specification of the programming language. Front-end component 402 may generate an intermediate translation, illustrated by intermediate translation 419, of source code 405. Intermediate addressable entity (AE) 421 illustrates an intermediate translation of source AE 411 in FIG. 4.

Front-end component 402 may build an internal representation of source code 405, such as a parse tree, and generate intermediate translation 419 and a symbol table (not shown) based on the internal representation. A symbol table may identify some or all symbolically identifiable entities defined in and/or translated from source code 405. A symbol table may include metadata about the identified entities such as data type metadata, location metadata, and/or scope metadata. The metadata that is maintained may depend on a programming language, a builder of a particular compilation system, and/or a user of a particular compilation system.

As used herein, the phrase “translated from” includes direct translations and indirect translations. That is, a second translation, which is generated from a first translation translated from particular source code, is translated from the particular source code as the phrase “translated from” is used herein.

One or more middle-end components (not shown) may process intermediate translation 419 and/or another translation generated from intermediate translation 419. Whether a middle-end component is included in the translating of source code 405 to target translation 407 may be configurable by a user.

Back-end component 417 may translate intermediate translation 419 and/or a translation generated from intermediate translation 419 into target translation 407. A target translation may include assembler code, byte code, machine code, and/or any data representation that is translatable into a machine code translation of source code 405. In FIG. 4 target translation 407 includes target addressable entity (AE) 423 translated from intermediate addressable entity 421, directly and/or indirectly.

Compilation system 403 may generate target translation 407 for translating to a machine code translation that is executable in execution environment 401 and also executable in an architecturally equivalent execution environment. Compilation system 403 may generate target translation 407 for translating to a machine code translation executable in one or more execution environments that are architecturally dissimilar from execution environment 401. For example, execution environments that include an IPU based on a common or shared IPU architecture may be considered architecturally equivalent. Dissimilar execution environments may include IPUs based on different IPU architectures.

An interpreted language may be compiled and a compiled language may be interpreted. For example, source code written in languages that are considered to be interpreted languages such as BASIC and ECMAScript may be compiled. Further, a compiled language, such as C, may be interpretable. Those skilled in the art understand that the distinction between compiling and interpreting is based on when and where a translation process occurs. Interpreters and compilers are both translators. Just-in-time (JIT) compilers and byte code interpreters are evidence supporting the previous statement as they blur the apparent distinctions between interpreters and compilers. The scope of the subject matter described herein includes translation of source code by interpreters and includes interpretable programming languages as translatable languages.

Compilation system 403 may present a user interface for interacting with a user. The user interface may be a graphical user interface (GUI) and/or a command line interface (CLI). FIG. 4 illustrates GUI subsystem 425 in execution environment 401. GUI subsystem 425 may include and/or otherwise provide access to a library of user interface element handler components (not shown) for presenting various types of user interface elements, such as windows, dialogs, and various types of input user interface controls. GUI subsystem 425 may manage routing of input to one or more applications presenting graphical user interfaces. Compilation system 403 may send presentation information to GUI subsystem 425 to present one or more visual interface elements via a display of execution environment 401. GUI subsystem 425 may instruct graphics subsystem 427 to draw the visual interface element(s) in a region of a presentation space for presentation by a display device.

Input may be received via one or more input drivers illustrated by input driver 429 in FIG. 4. Compilation system 403 may support a graphical user interface, a command line user interface, and/or a programming interface.

As stated, the various adaptations of the arrangements in FIG. 4 are not exhaustive. For example, those skilled in the art will see based on the description herein that arrangements of components for performing the method illustrated in FIG. 2 may be distributed across more than one execution environment.

With reference to FIG. 2, block 202 illustrates that the method includes receiving source code including a first addressable entity specified in a programming language. Accordingly, a system for processing an excludable addressable entity includes means for receiving source code including a first addressable entity specified in a programming language. For example, as illustrated in FIG. 3, front-end component 302 is configured for receiving source code including a first addressable entity specified in a programming language. FIG. 4 illustrates front-end component 402 as an adaptation and/or analog of front-end component 302 in FIG. 3. One or more front-end components 402 operate in execution environment 401.

As described above, FIG. 4 illustrates front-end component 402 for receiving source code from a user, from a data store, and/or via a network. FIG. 4 illustrates source code 405 stored in local data store 409. Source code 405 includes an addressable entity, illustrated by source AE 411, specified in a programming language. Source code 405 may include other addressable entities in addition to source AE 411.

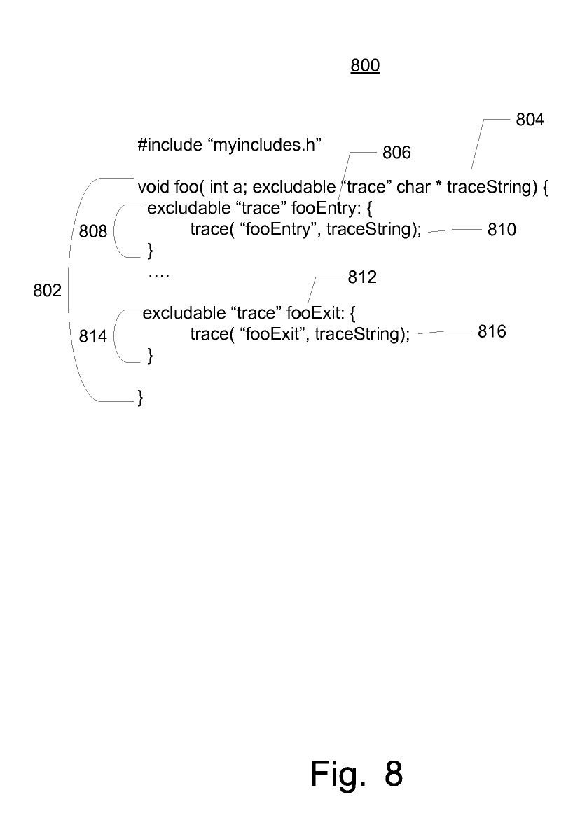

FIG. 8 illustrates source code 800 written in the C programming language adapted according to an aspect of the subject matter described herein. Source code 800 includes multiple addressable entities. One of the addressable entities illustrated in FIG. 8 includes “foo” addressable entity 802 specified as a function. FIG. 8 also illustrates “traceString” addressable entity 804 specified as a pointer to a storage location including one or more values of data type “char” defined by the C language. Both the pointer specified by “traceString” addressable entity 804 and the storage location(s) of one or more “char” values are addressable entities specified by source code 800. “fooEntry” addressable entity 806 is specified as a label identifying a location in “foo” addressable entity 802. “fooEntry” label 806 also identifies code block 808 defined by a pair of bracket symbols, “{” and “}”, as an addressable entity including a trace statement addressable entity 810 specified to configure an IPU to call a “trace” addressable entity (not shown) referenced as a function in the C source code 800. Another label, “fooExit” addressable entity 812, is specified identifying another location in “foo” addressable entity 802. Code block 814 is defined by a pair of bracket symbols and may be identified by “fooExit” label 812. Code block 814 includes another trace statement 816 referencing a “trace” addressable entity (not shown). The trace function may write a record to a trace log stored in a processor memory and/or in a persistent data store to trace the execution of an executable including a machine code translation of source code 800.

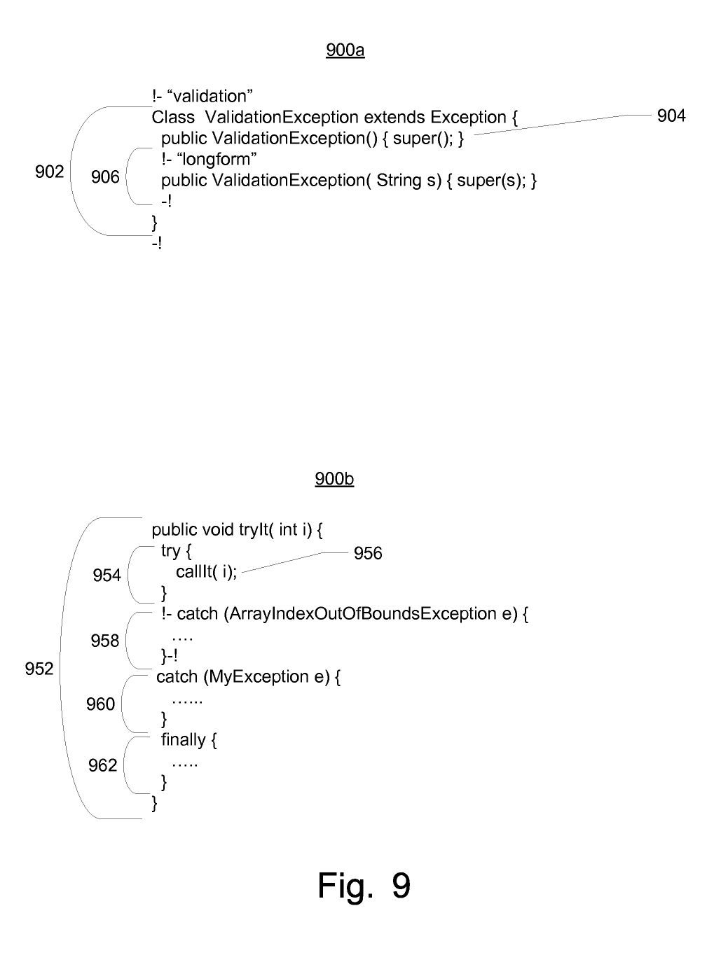

FIG. 9 illustrates source code 900a and source code 900b written in an adaptation of the JAVA^{TM} programming language according to another aspect of the subject matter described herein. Source code 900a includes multiple addressable entities. One of the addressable entities illustrated in source code 900a includes “ValidationException” addressable entity 902 specified as a JAVA class. Source code 900a also includes first “ValidationException” addressable entity 904 specified as a constructor for the ValidationException class and a second “ValidationException” addressable entity 906 as a second constructor for the class. Source code 900b illustrates “trylt” addressable entity 952 specified as a method in a class (not shown). “trylt” addressable entity 952 includes “try” addressable entity 954 specified as a code block including “can't” addressable entity 956 specified as a statement for invoking a referenced “can't” method included in the class with “tryIt” addressable entity 952. “try” addressable entity 954 is followed by first “catch” addressable entity 958, second “catch” addressable entity 960, and “finally” addressable entity 962, all specifying exception handling code blocks according to the adaptation of the JAVA^{TM} language.

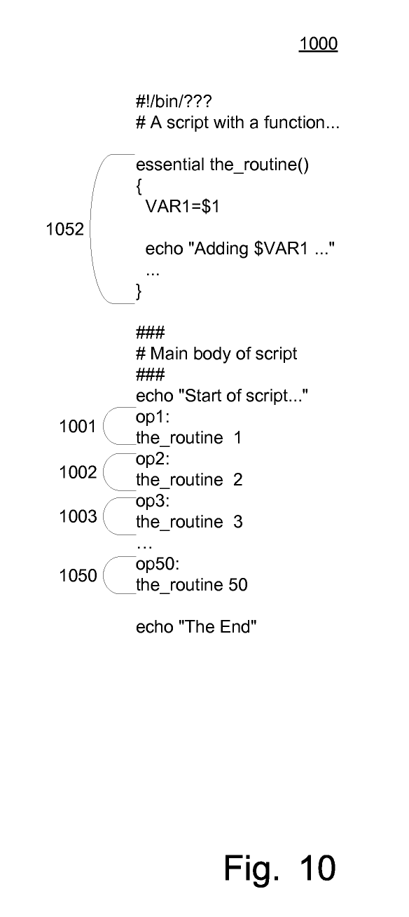

FIG. 10 illustrates source code 1000 written in a scripting language, such as the BASH shell script language, adapted according to yet another aspect of the subject matter described herein. Source code 1000 illustrates “the_routine” addressable entity 1052 specified as a subroutine. FIG. 10 also illustrates “op1” addressable entity 1001, “op2” addressable entity 1002, and “op3” addressable entity 1003 through “op50” addressable entity 1050, each specified as a labeled location in the script corresponding to a script instruction for invoking “the_routine” addressable entity 1052 referenced in the respective instructions.

Returning to FIG. 2, block 204 illustrates that the method further includes detecting in the source code an excludable indicator indicating that the first addressable entity is excludable from a second translation of the source code. Accordingly, a system for processing an excludable addressable entity includes means for detecting in the source code an excludable indicator indicating that the first addressable entity is excludable from a second translation of the source code. For example, as illustrated in FIG. 3, token handler component 304 is configured for detecting in the source code an excludable indicator indicating that the first addressable entity is excludable from a second translation of the source code. FIG. 4 illustrates token handler component 404 as an adaptation and/or analog of token handler component 304 in FIG. 3. One or more token handler components 404 operate in execution environment 401.

In FIG. 4, front-end component 402 may invoke token handler component 404 for building a parse tree, a syntax tree, a symbol table, and/or for otherwise identifying metadata based on received source code 405. A parse tree includes an ordered tree or hierarchy of nodes representing the syntactic structure of some or all source code statements in source code, such as source code 405. The syntactic structure may be based on a formal grammar or schema included in a specification and/or definition of a programming language in which the source code is represented. A syntax tree represents a tree or hierarchy of the syntactic structure of source code 405 according to the programming language.

A symbol table may identify some or all addressable entities defined in and/or generated from source code 405. A symbol table may include metadata about the addressable entities such as data type metadata, location metadata, and/or scope metadata. Metadata that is maintained may depend on the programming language of source code 405, a programmer writing source code 405, and/or a designer and/or builder of compilation system 403.

Token handler component 404 may generate and/or otherwise process some or all of a parse tree, a syntax tree, a symbol table, and/or other suitable representation of the source to detect an indicator that an addressable entity may be excluded from a translation of source code 405. Token handler component 404 in one aspect may scan one or more statements, instructions, declarations, and/or definitions in source code 405 to detect a keyword. A keyword may be defined by a programming language to indicate that an addressable entity is excludable.

FIG. 8 illustrates the string “excludable” that may be reserved in an adaptation of the C programming language according to the subject matter described herein. The “excludable” keyword may be defined by the language to extend the programming language's type definition syntax and semantics to include addressable entity data types that are excludable. The keyword “excludable” may be defined by the programming language to identify an addressable entity as having an excludable type. A translator, of source code specifying an excludable addressable entity, may exclude the addressable entity from a first translation of the source code and/or may provide excluding information for excluding the addressable entity from a translation of the first translation, based on the addressable entity's specified type.

FIG. 8 illustrates “traceString” addressable entity 804 as an excludable parameter from “foo” addressable entity 802. FIG. 8 also illustrates that a programming language may define a keyword for identifying the contents of a labeled location as excludable. In FIG. 8 the “excludable” keyword may be defined in another context by the programming language to identify “fooEntry” code block 808 as excludable from a translation, such as a machine code translation of source code 800. In an analogous manner FIG. 8 also illustrates that the specification of “fooExit” code block 814 includes the “excludable” keyword as an excludable indicator defined by the programming language in which source code 800 is represented in FIG. 8.

FIG. 9 illustrates syntactic elements “!-” and “-!” that may be defined by a programming language to indicate that one or more addressable entities specified within enclosing pairs of the elements “!-” and “-!” are excludable. Addressable entities enclosed in pairs of the elements may be nested. FIG. 9 illustrates source code 900a including an excludable indicator indicating “ValidationException” class addressable entity 902 is excludable. Source code 900a illustrates a definition of an addressable entity. An addressable entity that includes a reference to an excludable addressable entity may be excludable according to a programming language. In another aspect, an addressable entity that includes a reference to an excludable addressable entity may be modifiable or rewritable. A programming language may specify how a translator should process a reference in an excludable addressable entity and/or a reference to an excludable addressable entity.

Source code 900a also includes an excludable indicator identifying “ValidationException” constructor addressable entity 906 as excludable. Source code 900a illustrates that excludable indicators may be nested. Nesting of excludable indicators is described in more detail below. Source code 900b illustrates that the syntactic elements “!-” and “-!” may be included in source code to identify one or more source code statements that may be identified as excludable. The specification for “catch” code block addressable entity 958 includes an excludable indicator for identifying “catch” code block addressable entity 958 as excludable.

FIG. 10 illustrates source code 1000 including an excludable indicator as the absence of an indicator that an addressable entity is not excludable. In an aspect, an addressable entity may be specified in a programming language as excludable or not excludable by default in the absence of an indicator. The specification of “the_routine” addressable entity 1052 in FIG. 10 illustrates an “essential” keyword that may be defined by the scripting language in FIG. 10 to indicate that an addressable entity is not excludable. “op1” addressable entity 1001, “op2” addressable entity 1002, “op3” addressable entity 1003, “op50” addressable entity 1050, and any other addressable entities specified in source code 1000 are detectable as excludable in the absence of an indicator defined by the scripting language indicating otherwise.

Those skilled in the art will understand, based on the descriptions herein, that keywords and syntactic elements illustrated in FIGS. 8, 9, and 10 are exemplary and not exhaustive. Any suitable indicator defined in and/or definable via a programming language may specify an excludable indicator. For example, a naming convention for addressable entities may be defined for providing excludable indicators. For example, a programming language may specify a name space for user defined symbolic identifiers for addressable entities where a suffix, such as “_optional”, may be added to any valid name in the name space to produce a valid name indicating that the named addressable entity is excludable. A portion of the name space including identifiers with the suffix may be reserved and/or otherwise defined for identifying excludable addressable entities.

Returning to FIG. 2, block 206 illustrates that the method yet further includes generating a first translation, of the source code, including a first translation of the first addressable entity. Accordingly, a system for processing an excludable addressable entity includes means for generating a first translation, of the source code, including a first translation of the first addressable entity. For example, as illustrated in FIG. 3, representation generator component 306 is configured for generating a first translation, of the source code, including a first translation of the first addressable entity. FIG. 4 illustrates representation generator component 406 as an adaptation and/or analog of representation generator component 306 in FIG. 3. One or more representation generator components 404 operate in execution environment 401.

FIG. 4 illustrates back-end component 417 interoperating with representation generator component 406 to generate a first translation of source code 405. The first translation is illustrated by target translation 407 in FIG. 4. Any translation whether internal to compilation system 403 and/or stored external to compilation system is a translation and is a target translation from the perspective of a particular component and/or phase included in translating source code 405 to target translation 407.

A translation is a target translation when it is the output of a translator. A translation is source code and/or a source translation when it is translated by a translator to another translation. Source code and a target translation of the source code may be at least partially represented in the same language. Similarly, a source translation and a target translation of the source code may be at least partially represented in the same language. For example, an object code translation of a source code component may include machine code. An executable translation, of the object code, stored in a processor memory may also include machine code. The language of the object code as a whole may be considered to be a different language from the language of the executable code in the processor memory as the syntax and rules may differ. For example, unresolved references may be allowed by the rules of an object code language, but not allowed by the rules of an executable language even though both may include machine code portions that are identical.

In an aspect, front-end component 402 may interoperate with an adaptation and/or analog of representation generator component 406 to generate intermediate translation 419 of source code 405. A middle-end component (not shown) may generate an intermediate translation. Target translation 407 may represent some or all of the source code as assembler, a high-level programming language, byte code, unlinked object code, and/or linked object code. Target translation 407 may include a relocatable machine code translation, a position independent translation, and/or an unrelocatable machine code translation.

Returning to FIG. 2, block 208 illustrates that the method yet further includes generating, in response to detecting the excludable indicator, excluding information identifying the first translation of the first addressable entity as excludable for excluding the first addressable entity from the second translation generated from the first translation of the source code. Accordingly, a system for processing an excludable addressable entity includes means for generating, in response to detecting the excludable indicator, excluding information identifying the first translation of the first addressable entity as excludable for excluding the first addressable entity from the second translation generated from the first translation of the source code. For example, as illustrated in FIG. 3, exclusion component 308 is configured for generating, in response to detecting the excludable indicator, excluding information identifying the first translation of the first addressable entity as excludable for excluding the first addressable entity from the second translation generated from the first translation of the source code. FIG. 4 illustrates exclusion component 408 as an adaptation and/or analog of exclusion component 308 in FIG. 3. One or more exclusion components 408 operate in execution environment 401.

In one aspect, a translation of source code specifying an excludable addressable entity may be generated to include a translation of the addressable entity represented in the same manner in which it would be represented if it was not excludable. For example, representation generator component 406 may generate target translation 407 of source code 405, including target AE 423 as a translation of source AE 411. Target AE 423 may be generated and represented in the same manner as a translation of source AE 411 would be if the addressable entity was not indicated as excludable. In the aspect, back-end component 417 may invoke exclusion component 408 providing excluding information identifying target AE 423 as excludable. A symbol table entry may be created for target AE 423 by front-end component 402. The symbol table entry may include an attribute specifying that the addressable entity is excludable. For example, “traceString” addressable entity 804 is specified as having “excludable char *” type according the programming language. A symbol table for target translation 407 may include an entry identifying the excludable type of the addressable entity.

Exclusion component 408 may associate some or all of a symbol table generated by front-end component 402 with target translation 407. Exclusion component 408 may generate metadata for locating and/or otherwise identifying a translation of the addressable entity in target translation 407. The metadata may be provided to a translator along with target translation 407 to translate target translation 407 into another target translation excluding any translation of the addressable entity. The addressable entity may be excluded based on the exclusion metadata. Systems and methods for excluding an addressable entity are described below.

In another aspect, representation generator component 406 and exclusion component 408 may be directed by back-end component 417 to operate in a combined, interleaved, and/or otherwise cooperative fashion to include some or all of the excluding information in target translation 407 including target AE 423. For example, a marker specified in the representation language of target translation 407 may be stored in a location in target translation 407 with target AE 423, such as just before target AE 423 and/or just after target AE 423. The marker may be defined as excluding information for identifying target AE 423 as excludable from a subsequent translation. The marker may constitute some or all of the excluding information.

The method illustrated in FIG. 2 may include additional aspects supported by various adaptations and/or analogs of the arrangement of components in FIG. 3. For example, as described above an excludable indicator may be defined to indicate that a specified addressable entity is excludable by a programming language in a variety of ways. Token handler component 304 in FIG. 3 may be adapted according to one or more of the various aspects.

In one aspect, an excludable indicator may be included in a declaration and/or a definition of an addressable entity specified in a programming language. “traceString” addressable entity 804 is specified in a declaration in source code 800 in FIG. 8 according to the C programming language. A definition of the “trace” function in trace statement addressable entity 810 may be included in “myincludes.h” The definition may include an excludable indicator. Token handler component 404 may detect an excludable indicator in a declaration and/or in a definition of an addressable entity.

In another aspect, an excludable indicator may be specified in a type defined by a programming language, such as the “int” type is defined in the C specification. Token handler component 404 may detect an excludable indicator in a type specification. FIG. 8 illustrates “traceString” addressable entity 804 specified as having the type “excludable char *” that may be defined in a specification of the C language according to the subject matter described herein. Alternatively or additionally, an excludable indicator may be defined in a user defined type. User defined types are types that are definable in a programming language. For example, a user may define a structured type with an “excludable” attribute defining an addressable entity with an excludable structured type according to a particular programming language.

Examples described above demonstrate that an excludable indicator may be specified by including a reserved word, also referred to as a keyword, reserved by a programming language for indicating that an addressable entity is excludable. The string “excludable” in FIG. 8 is included in multiple excludable indicators as a reserved word in a version of the C language extended according to the subject matter described herein.

In another aspect, a programming language may define a naming convention for indicating that an addressable entity is excludable. Token handler component 404 may detect an excludable indicator in and/or otherwise based on an addressable entity name or identifier. For example, a programming language may specify that identifiers that include “_ex” as a postfix are identifiers of excludable addressable entities. This example illustrates that a name space defined by a programming language for identifiers of addressable entities may include a portion of the name space defining identifiers of excludable addressable entities. A portion of a name space reserved for identifying an addressable entity may be defined by a naming convention as just illustrated, may be definable according to a programming language by a user, and/or may be defined as one or more identifiers reserved for identifying excludable addressable entities and explicitly specified, for example, in a list.

An addressable entity or a portion thereof is associated with one or more locations. For example, an addressable entity may be defined according to a language in one location, declared in another location, and/or referenced in yet another location in source code, and a translation of an addressable entity is associated with one or more locations in a translation of the source code. Exclusion component 408 may include information in excluding information that identifies one or more locations corresponding to an addressable entity in a translation. For example, a location may be identified by an address such as an offset into a file and/or a location may be identified by a marker or symbol for a matching location. A location identifier may be based on another identifier. For example, an identifier may identify an addressable entity within an identified scope and/or relative to a location of another addressable entity. For example, in FIG. 9 a location of a translation of “catch” addressable entity 958 may be identified relative to a location of “trylt” addressable entity 952. “catch” addressable entity 958 is declared in the scope of “trylt” addressable entity 952 in source code 900b. “catch” addressable entity 958 does not exist outside of the scope of “trylt” addressable entity 952.

An excludable indicator may include a non-alphanumeric symbol defined by the programming language for indicating that the addressable entity is excludable. FIG. 9 illustrates excludable indicator pair “!-” and “-!” expressed in a non-alphanumeric manner.

In yet another aspect, a programming language may be specified to identify an addressable indicator by an absence of an indicator indicating that the addressable entity is not excludable. FIG. 10 illustrates indicator “essential” defined by the scripting language in FIG. 10 to identify an addressable entity that is not excludable. “op1” addressable entity 1001 is specified in FIG. 10 without the “essential” indicator and may be identified as excludable according to a specification of the scripting language.

A programming language may specify or define a format, a syntax, a vocabulary, and/or a grammar for expressing a valid excludable indicator in the programming language as described above and illustrated in FIG. 8, FIG. 9, and FIG. 10. The string “excludable” may be defined as a reserved keyword for including in an excludable indicator. A programming language may specify one or more such keywords defining a vocabulary for at least a portion of an excludable indicator for the language.

A programming language may define an excludable indicator to allow excludable indicators to identify one or more attributes. FIG. 9 illustrates that an excludable indicator may be specified that includes a tag and/or other annotation as an attribute of an excludable indicator. The annotation attribute value may be predefined by the programming language and/or may be user defined. “ValidationException” class addressable entity 902 includes a tag “validation”, and “Validation Exception” constructor addressable entity 906 includes a “longform” tag. A matching criterion that matches “validation” may be defined for excluding “ValidationException” class addressable entity 902 from a subsequent translation. A matching criterion that matches “longform” may be defined for excluding “ValidationException” constructor addressable entity 906 while not excluding other portions of “ValidationException” class addressable entity 902. One or more of “validation” and “longform” may be specified by the programming language or may be user defined according to the programming language. An attribute identified by an excludable indicator may include a tag, a phrase, a symbol, a symbolic expression, a condition, a logical expression, a mathematical expression, and/or other annotation. Token handler component 404 may detect attributes identified by an excludable indicator, and exclusion component 408 may generate excluding information that identifies the one or more attributes and/or is otherwise based on the one or more attributes.

Excluding information may be stored by back-end component 417 external to a generated translation and/or may be included in a translation.

Excluding information may identify a location of an addressable entity in a translation of source code based on a programming language specifying the source code and/or a representation language of the translation. The location may be based on a format, a syntax, a grammar, and/or a vocabulary defined by the programming language of the source code and/or the representation language of the translation. Excluding information may identify an attribute of an excludable indicator. The attribute may be specified in the source language code and/or the representation language of the translation. The attribute may be specified according to the source language by a user. The attribute may include a tag, a phrase, a symbol, a symbolic expression, a condition, a logical expression, a mathematical expression, and/or other annotation in the source code. The attribute may be included in determining whether an associated excludable addressable entity is to be excluded from a second translation as described below.

A translation of source code including and/or otherwise associated with excluding information may include an assembler language statement, a statement in a high-level programming language, object code, byte code, and/or machine code.

FIG. 7 illustrates execution environment 701 hosting loader subsystem 703 for loading a program component translated from source code into a processor memory of execution environment 701 for accessing by an IPU to execute one or more machine code instructions included in the machine code translation of the source code. FIG. 7 illustrates an adaptation of the arrangement of components in FIG. 6 in loader subsystem 403. In loading a program component, loader subsystem 703 translates a program component into an executable translation of the program component. For example, loading a byte code translation of a source code component includes translating the byte code translation into a machine code translation. Loading an object code translation includes translating the object code, which may include machine code, into a machine code translation in an address space of an IPU for executing. The arrangement of components in FIG. 6 may also be adapted to operate in a translator such compilation system 403 in FIG. 4.

FIG. 7 illustrates loader component 705 in loader subsystem 703. Loader component 705 may receive a first translation generated from source code written in a programming language. The first translation may be generated by a compilation or translation system such as compilation system 403 in FIG. 4 described above. The first translation may be any target translation described above, an analog, and/or an equivalent.

Loader component 705 may access a first translation from a variety of types of data stores storing data in various types of data storage media. FIG. 7 illustrates first translation 707 as an input translation stored in local data store 709. Loader component 705 may receive first translation 707 stored, for example, in a file accessible via file system 711. File system 711 may access a data storage medium or media in local data store 709 via data storage media driver 713.

In various aspects, a loader subsystem may be included in an operating system in an execution environment, may be part of an application and/or component in an execution environment, and/or may operate in an execution environment that does not include an operating system. Loader subsystem 703 is included in loading programs into a processor memory of execution environment 701. The processor memory is defined by an address space of an IPU in execution environment 701. When loaded into the processor memory and/or mapped into the processor memory, a loaded program component is accessible to the IPU for accessing one or more machine code instructions in the loaded program for executing by the IPU.

First translation 707 stored in local data store 709 may include machine code that is executable by the IPU when translated into an executable translation in an address space defining a processor memory of the IPU. In another aspect, first translation 707 may include intermediate code, such as byte code, that is translated into machine code for loading. Loader subsystem 703 may be included in translating intermediate code. One or more components of a compilation system, such as compilation system 403 in FIG. 4, may be invoked to perform at least part of the translation of first translation 707 into a second translation. Second translation 715 illustrates an aspect where first translation 707 is translated to an executable machine code translation in an address space of an IPU in execution environment 701. In another aspect, second translation 715 may be translatable into an executable machine code translation. Loader subsystem 703 may include and/or otherwise interoperate with a compilation system.

Some or all of compilation subsystem 403 may be stored persistently in a physical processor memory of execution environment 401. In another aspect, some or all of loader subsystem 703 may be persistently stored in a virtual processor memory allowing one or more persistently stored portions to be paged in and out of physical processor memory 719.

Translating first translation 707 may include copying machine code in first translation 707 in an object code translation of source code into second translation 715 in a processor memory. FIG. 7 illustrates copy component 717 for copying machine code in second translation 715 in a region of processor memory 719. In another aspect, second translation 715 may not be a machine code translation loaded into processor memory 719 for executing, but is rather translatable into a machine code translation storable in a processor memory for executing.

An IPU in execution environment 701 may have an address space defining a virtual processor memory. Loader subsystem 703 may map at least some machine code in a machine code translation stored in persistent storage into the virtual processor memory without copying the machine code from its current location in storage. FIG. 7 illustrates map component 721 in loader component 705 for providing mapping information to memory manager component 723. Memory manager component 723 may page and/or otherwise copy portions of the machine code in an executable second translation 715 into a physical processor memory based on the mapping information as required for access by the IPU. Translating may include resolving unresolved references if any, adding heap and stack space, and initializing IPU registers for the executable translation. A memory mapped file is an example of data that may be mapped into a virtual processor memory.

Translating a first translation into a second translation may include translating a symbolic reference into another symbolic reference and/or may include resolving a symbolic reference with an address. An unresolved reference may be resolved through a linking process performed by a linker. Loading and linking may be performed as separate processes or may be performed as a combined process. Loader subsystem 703 may support loading separate from linking and/or may support a combined process. A linker may be included in an execution environment as a separate component and/or subsystem from a loader subsystem. Alternatively or additionally a loader subsystem may include some or all of one or more components for performing linking. FIG. 7 includes linker 725 as a component external to loader subsystem 703.

Generating second translation 715 by loader component 705 may include loading or copying machine code in first translation 707 into an existing processor memory. In another aspect, loader subsystem 703 may allocate and/or identify a new address space of an IPU in execution environment 701. The address space includes addresses that define a new processor memory into which the machine code translation or a portion thereof may be loaded and/or into which the machine code translation or a portion thereof may be mapped. First translation 707 may include information, for example in a header, specifying a size and/or amount of memory needed for loading. Loader subsystem 703 may interoperate with memory manager component 723 to allocate addresses in the address space defining one or more segments in the processor memory. Loader subsystem 703 may read and/or generates machine code for second translation 715 from first translation 707. Loader component 705 may store the machine code in the one or more segments of processor memory 719 defined by the addresses allocated from the address space.

Translating first translation 707 into second translation 715 may include writing zeros or some other specified data into unused and/or uninitialized portions of the one or more segments in the processor memory. Loader component 705 and/or memory manager component 723 may perform some or all of this operation. For programs that operate according to a stack-based execution model, translating first translation 707 into second translation 715 may include creating one or more stack segments in processor memory 719 by allocating addresses from the address space to define the regions in processor memory 719 for one or more stack segments. Loader component 705 and/or memory manager component 723 may perform some or all of this aspect of translation.

FIG. 7 illustrates context component 727 in loader component 705. Context component 727 may set and store one or more program inputs and/or other run-time information configured for the machine code translation loaded into the processor memory. Translating may include establishing a process context. Context component 727 may configure a process context in which second translation 715 is accessed by an IPU of execution environment 701. FIG. 7 illustrates initiate component 729 in loader component 705. Translation may include starting execution of second translation 715. FIG. 7 illustrates initiate component 729 for starting execution. Initiate component 729 may configure an IPU in execution environment 701 to access a machine code instruction in the machine code translation.

When loading by memory mapping, loader 705 may create segments by allocating addresses from an address space as described above. Loader 705 may map machine code in first translation 707 into the one or more segments of processor memory 719 defined by the allocated addresses. This may include mapping portions of first translation 707 into pages and setting permissions for read-only, copy-on-write, or other permission suitable for a page and/or a segment.

With reference to FIG. 5, block 502 illustrates that the method includes receiving a first translation, translated from source code including a first addressable entity specified in a programming language, including a first translation of the first addressable entity. Accordingly, a system for excluding an addressable entity from a translation of source code includes means for receiving a first translation, translated from source code including a first addressable entity specified in a programming language, including a first translation of the first addressable entity. For example, as illustrated in FIG. 6, translation director component 602 is configured for receiving a first translation, translated from source code including a first addressable entity specified in a programming language, including a first translation of the first addressable entity. FIG. 7 illustrates translation director component 702 as an adaptation and/or analog of translation director component 602 in FIG. 6. One or more translation director components 702 operate in execution environment 701.

As described above, FIG. 7 illustrates translation director component 702 for receiving a first translation of source code, such as first translation 707, from a data store, from a user, and/or via a network. FIG. 7 illustrates first translation 707 stored in local data store 709. First translation 707 includes a translation of source code where the source code is written in a programming language. First translation 707 further includes a first translation of an addressable entity where the addressable entity is specified in the programming language in the source code. FIG. 7 illustrates first translated addressable entity (AE) 731 and may include other translations of other addressable entities specified in the source code according to the programming language.

In an aspect, some or all of first translation 707 may be generated from source code 800 illustrated in FIG. 8. First translation 707 when translated from source code 800 includes first translations for source code 800 specifying “traceString” AE 804, “fooEntry” AE 806, and “fooExit” AE 812. First translated AE 731 in FIG. 7 may include a first translation of one or more of “traceString” AE 804, “fooEntry” AE 806, and “fooExit” AE 812.

In another aspect, some or all of first translation 707 may be generated from source code 900a and source code 900b in FIG. 9. When translated from source code 900a, first translation 707 includes first translations for the source code specifying “Validation Exception” class AE 902 and “Validation Exception” constructor AE 906. First translated AE 731 in FIG. 7 may include a first translation of one or more of “ValidationException” class AE 902 and “ValidationException” constructor AE 906. When generated from source code 900b, first translation 707 includes first translations for the source code specifying first “catch” AE 958. First translated AE 731 in FIG. 7 may include a first translation of first “catch” AE 958.

In yet another aspect, some or all of first translation 707 may be generated from source code 1000 in FIG. 10. When generated from source code 1000, first translation 707 includes first translations for the source code specifying “op1” AE 1001, “op2” AE 1002, “op3” AE 1003, through “op50” AE 1050. First translated AE 731 in FIG. 7 may include a first translation of one or more of “opt” AE 1001, “op2” AE 1002, “op3” AE 1003, through “op50” AE 1050.

Returning to FIG. 5, block 504 illustrates that the method further includes detecting excluding information identifying the first translation of the first addressable entity as excludable from a second translation, of the source code, translated from the first translation Accordingly, a system for excluding an addressable entity from a translation of source code includes means for detecting excluding information identifying the first translation of the first addressable entity as excludable from a second translation, of the source code, translated from the first translation. For example, as illustrated in FIG. 6, exclusion manager component 604 is configured for detecting excluding information identifying the first translation of the first addressable entity as excludable from a second translation, of the source code, translated from the first translation. FIG. 7 illustrates exclusion manager component 704 as an adaptation and/or analog of exclusion manager component 604 in FIG. 6. One or more exclusion manager components 704 operate in execution environment 701.

FIG. 7 illustrates exclusion manager component 704 for receiving and/or otherwise detecting excluding information. Excluding information may be generated as described above according to the method illustrated in FIG. 2 by an adaptation and/or analog of the arrangement of components illustrated in FIG. 3. As described above, an arrangement of components such as in compilation system 403 in FIG. 4 may generate first translation 707 and may produce excluding information identifying first translated AE 731.

Exclusion manager component 704 may detect some or all excluding information in and/or otherwise identified by a symbol table entry for first translated AE 731. The symbol table entry may include an indicator specifying that the addressable entity is excludable as described above. Alternatively or additionally, exclusion manager component 704 may detect excluding information in metadata not in the symbol table. Metadata identifying a translation of an addressable entity as excludable may identify a location of a translation of the addressable entity in a translation of source code.

Excluding information for first translated AE 731 may be included, at least in part, in first translation 707. Excluding information for first translated AE 731 may be stored at least in part in first translated AE 731. Excluding information may be generated based on an excludable indicator defined by the programming language of the source code translated into first translation 707. The excluding indicator in the source code may be translated into an excluding indicator in a representation language of first translated AE 731. Excluding information may include an excluding indicator. An excluding indicator in excluding information may include any of the forms described above and illustrated in FIG. 8, FIG. 9, and FIG. 10. An assembler language, an object code language, a byte code language, a machine code language, and/or any representation language for a translation of source code may define an excludable indicator in the language and/or may allow a user to define an excludable indicator according to the language.

Returning to FIG. 5, block 506 illustrates that the method yet further includes receiving translation configuration information for translating the first translation. Accordingly, a system for excluding an addressable entity from a translation of source code includes means for receiving translation configuration information for translating the first translation. For example, as illustrated in FIG. 6, configuration access component 606 is configured for receiving translation configuration information for translating the first translation. FIG. 7 illustrates configuration access component 706 as an adaptation and/or analog of configuration access component 606 in FIG. 6. One or more configuration access components 706 operate in execution environment 701.

In an aspect, translation director component 702 may interoperate with configuration access component 706 to receive and/or otherwise detect translation configuration information. Some or all translation configuration information may be included in and/or otherwise identified by excluding information generated for a translation of an addressable entity as described above with respect to FIG. 4. Translation configuration information may be included in first translation 707 and/or may be stored external to first translation 707.

In another aspect, configuration access component 706 may receive translation configuration information including and/or otherwise identifying a policy or condition for excluding a translation of an addressable entity identified as excludable based on corresponding excluding information. A policy or condition may include and/or otherwise be based on a matching criterion for determining whether to exclude an excludable addressable entity from a second translation of a first translation of source code.

A policy or condition may be predefined for execution environment 701. A predefined policy or condition may be received and/or identified by configuration access component 706 in response to user input selecting and/or otherwise associating the predefined policy or condition with translation configuration information for first translation 707. Alternatively of additionally, a policy or condition may be specified based on information received from a user, as may any other information included in and/or otherwise identified by translation configuration information.

FIG. 8 illustrates that a programming language keyword may be defined in a syntax defined by the programming language for specifying one or more attributes for determining whether a matching criterion may be met. In FIG. 8, “trace” is illustrated as an annotation attribute in a syntax allowing a quoted string to follow the “excludable” reserved word. The quoted string may identify one or more tags for classifying and/or otherwise labeling one or more excludable addressable entities. For example, “traceString” AE 804 and “fooExit” AE 812 are both tagged with the term “trace”. This may indicate that the addressable entities are included in writing a trace or log of an execution of a machine code translation including and/or referencing machine code translations of “traceString” AE 804 and “fooExit” AE 812.

Translation configuration information may specify an exclude condition based on a matching criterion that may be met when evaluated with the tag “trace” received as an input. For example, translation configuration information may include a directive such as <exclude tag=“trace |log”/>. The directive written in XML may be defined according to a schema defining at least one of a format and a vocabulary for some or all of a translation configuration information file, record, and/or data structure. The directive may be received in and/or otherwise identified by translation configuration information received by configuration access component 706 for detecting and/or locating translated addressable entities tagged with one or both of the tags “trace” or “log”.

A matching criterion may be specified for determining whether an addressable entity is to be excluded from a translation of a first translation of source code 900a in FIG. 9. A matching criterion may be specified based on available attribute information in the first translation. For example, a first translation may include and/or otherwise be associated with a symbol table generated from source code for the first translation. Translation configuration information detected in a file associated with first translation 707 and/or included in first translation 707 may include a matching criterion based on information maintained in the symbol table and/or in other metadata in and/or otherwise associated with first translation 707.

For example, “com.OoOT.Exceptions.ValidationException” may be included in an “exclude.txt” file as translation configuration information. The string may specify that excludable addressable entities located in a JAVA™ class hierarchy identified by “exclude.txt” are to be excluded from a translation. A line including “com.OoOT.examples.exceptionTest.tryit” identifies one or more methods having the name “trylt” in an exceptionTest class. This identifies a more specific location, namely a method, than the previous line that identified a class.

In FIG. 10, translation configuration information may specify a matching criterion based on a label in source code 1000. “exclude: op3-op5” in translation configuration information may identify locations in first translation 707 to locate addressable entities to exclude. In one aspect, respective locations in first translation 707 corresponding to labeled locations in source code identified by “op3”, “op4”, and “op5” may be identified via a reserved symbol and/or identifier in a first representation language in which first translation 707 is represented. The reserved symbol and/or identifier may be defined to identify an excludable addressable entity represented in the first representation language. A naming convention, name space, and/or symbol table represented in the first representation language may be defined in the first representation language for identifying an excludable addressable entity.

Any suitable indicator definable in a representation language may specify an excludable indicator. A naming convention for addressable entities may be defined for providing excludable indicators. For example, a representation language may specify a name space for translator generated symbolic identifiers for addressable entities translated from excludable addressable entities specified in source code.

As described above, translation configuration information may specify a matching criterion that is met when evaluated with “trace” as an input. Exclusion manager component 704 may determine whether a matching criterion specified in translation configuration information is met for an excludable addressable entity tagged with “trace”. For example, exclusion manager component 704 may determine that translation configuration information including the directive <exclude tag=“trace |log”/>is met for “traceString” AE 804, “fooEntry” AE 806, and “fooExit” AE 812. The “trace” keyword may be included in the first translation of the source code and/or may be maintained separate from the first translation of the source code.

Also as described above, translation configuration information may specify a matching criterion that is met when evaluated based on attribute information in a symbol table and/or other data associated with a translation. Exclusion manager component 704 may determine whether a matching criterion specified in translation configuration information is met for an excludable entity identified by a name matching a matching criterion. For example, exclusion manager component 704 may determine that translation configuration information including a name matching expression “*.Exception.*” is met for “ValidationException” class AE 902 and “ValidationException” constructor AE 906.

Other matching criteria may be included in translation configuration information to narrow a matching condition or to expand it. Logical operations such as “and” and “or” operators and/or analogs may allow for more complex matching conditions to be configured. For example, an addressable entity type criterion such as AEType=“method” specified as a keyword-value pair in translation configuration information may identify “ValidationException” constructor AE 906 for excluding when combined with the name matching criterion, but not identify “ValidationException” class AE 902.

With respect to FIG. 10, translation configuration information may specify a matching criterion that is met based on matching label identifiers specified in a programming language. Locations of translated addressable entities identified by the labels may be stored in symbol table entries for the respective labels. Exclusion manager component 704 may determine whether a matching criterion specified in translation configuration information is met for an excludable entity at a location labeled in the programming language with “op1”. For example, exclusion manager component 704 may determine that translation configuration information, including the matching criterion “exclude: op3-op5”, is met for labeled locations “op3” AE 1003 through “op5” AE (not shown) in labeled locations “op1” through “op50”. A schema for the translation configuration may define a format and/or a vocabulary identifying “exclude: op3-op5” as a valid matching criterion expression.

Returning to FIG. 5, block 508 illustrates that the method additionally includes translating, in response to receiving the translation configuration information, the first translation into the second translation excluding, based on the excluding information, the first addressable entity. Accordingly, a system for excluding an addressable entity from a translation of source code also includes means for translating, in response to receiving the translation configuration information, the first translation into the second translation excluding, based on the excluding information, the first addressable entity. For example, as illustrated in FIG. 6, the translation engine component 608 is configured for translating, in response to receiving the translation configuration information, the first translation into the second translation excluding, based on the excluding information, the first addressable entity. FIG. 7 illustrates translation engine component 708 as an adaptation and/or analog of translation engine component 608 in FIG. 6. One or more translation engine components 708 operate in execution environment 701.

In FIG. 7, exclusion manager component 704 may identify to translation engine component 708 a location of a translation of an addressable entity in a first translation. Translation director component 702, in an aspect, may direct the interoperation of exclusion manager component 704 and translation engine component 708. Translation engine component 708 may generate an intermediate translation and/or may generate an executable translation, in a machine code representation language, stored in a processor memory of execution environment 701.

In one aspect, translation engine component 708 may translate first translation 707 skipping the excludable first translated addressable entity 731 and/or other addressable entities identified by exclusion manager component 704. In another aspect, translation engine component 708 may generate a translation including a second translation of first translated AE 731. Translation engine component 708 may then remove second translations of the one or more addressable entities from the second translation of the source code.

When producing code for loading into a processor memory for execution, translation engine component 708 may interoperate with loader component 705 to exclude the one or more addressable entities when loading the second translation into a processor memory as machine code for execution in execution environment 701.

In another aspect, translating the first translation may include mapping the first translation into a processor memory accessible to an IPU in execution environment 701 in a process that includes not mapping first translated AE 731 into processor memory 719. That is, second translation 715 may be a memory mapped translation of first translation 707 where excludable addressable entities in first translation 707 are not memory mapped.

The method illustrated in FIG. 5 may include additional aspects supported by various adaptations and/or analogs of the arrangement of components in FIG. 6. Exemplary types of representation languages for a first translation including a first translation of an excludable addressable entity and for a second translation, of the first translation, excluding the addressable entity include array languages, object-oriented languages, aspect-oriented languages, assembler languages, command line interface languages, functional languages, list-based languages, procedural languages, reflective languages, scripting languages, and stack-based languages.

A translation of the addressable entity may be a translation of a variable, a constant, a function, a subroutine, a procedure, a module, a method, a class, an object, a code block, and/or an instruction identified by a label.

Excluding information may identify a location of a translation of an addressable entity in a first translation. The location may be identified based on a format, a syntax, a grammar, and/or a vocabulary defined by the programming language of the source code and/or the representation language of the first translation.

Excluding information may identify an attribute of an addressable entity. An attribute may be defined by the programming language of the source code and/or the representation language of the first translation. More particularly, the attribute may be an attribute specified by and/or in an excludable indicator. An attribute may be specified by a user according to the programming language of the source code and/or the representation language of the first translation. Exemplary attributes include a tag, a phrase, a symbol, a symbolic expression, a condition, a logical expression, a mathematical expression, and/or an annotation.

A language of a translation including an excludable addressable entity may define a name space for addressable entity identifiers. A portion of the name space may include identifiers for identifying excludable addressable entities according to the language. First translated AE 731 may be identified in first translation 707 from a portion of a name space defined by the language, where the portion is defined for identifying excludable addressable entities.

Translation configuration information may be retrieved from a data store, via a network, and/or from a user, in response to a translate indicator for translating the first translation. In one aspect, translation director component 702 may receive an identifier of first translation 707 in local data store 709. Receiving the identifier may be a translate indicator. In response, translation director component 702 may invoke and/or otherwise interoperate with configuration access component 706 to retrieve translation configuration information for first translation 707. Translation configuration information may be specific to a particular first translation to translate to a second translation or may be associated with more than one or more source translations to be translated to respective target translations. Particular translation configuration information may be associated with a particular translation to be translated based on a naming convention, a storage location of the translation and/or of the translation configuration information, a user, a group, a node, a portion of a network, a geospatial location, an organization, a mode setting, and/or any other suitable attribute for associating two pieces of data.

As described above, some or all of translation configuration information for translating a first translation to a second translation may be included and/or otherwise identified by excluding information for the first translation.

Translating a first translation to a second translation excluding an excludable addressable entity may include identifying a location, in the first translation, including some or all of a first translation of an excludable addressable entity, and not translating the some or all of the first translation of the addressable entity in the location to a second translation of the addressable entity. Exclusion manager component 704 in FIG. 7 may provide location information identifying one or more locations in first translation 707 to translation engine component 708 to skip.

In still another aspect, excluding an addressable entity may include translating an intermediate translation of a first translation that includes an intermediate translation of an excludable addressable entity. In the aspect, the intermediate translation of the addressable entity may be removed from the intermediate translation. The intermediate translation with the addressable entity removed may be translated to a second translation. Translation engine component 708 may track a location of an addressable entity during translation to a target translation for removing the translated addressable entity from the target translation.

Excluding an addressable entity may include determining that an exclude condition identified by translation configuration information is met based on excluding information for an excludable addressable entity. In response to determining that the exclude condition is met, the addressable entity may be excluded from a second translation of source code specified in a programming language. As described above, exclusion manager component 704 in FIG. 7 may be configured to evaluate a variety of exclude conditions based on various types of excluding information in various aspects.

An exclude condition may be based on an attribute of an addressable entity. The attribute may be defined by the programming language of the source code and/or a first representation language of a first translation. Alternatively or additionally, some or all of an attribute of an exclude condition may be specified, based on information received from a user, according to the programming language of the source code. An attribute of an exclude condition may be specified based on information received from a user according to the first representation language.

Exemplary attributes that an exclude condition may be based on include a tag, a phrase, a symbol, a symbolic expression, a condition, a logical expression, a mathematical expression, and/or an annotation. For example, a user may specify a mathematical expression as an attribute of an excludable indicator. The expression may include a variable. A value for the variable may be identified in translation configuration information. Given the value, the expression may be evaluated by exclusion manager component 704 to produce a result. A determination whether to exclude an addressable entity or not from a translation may depend on the result.

An exclude condition may be based on at least one of translation configuration information and exclude information that includes and/or otherwise identifies a type of an addressable entity. The type may be defined by and/or definable in at least one of a programming language of source code and a first representation language of a first translation of the source code. The type may be included in the translation configuration information and/or the exclude information for matching. An exclude condition may include and/or otherwise identify a matching criterion based on a type. A type may be an input for evaluating a matching condition.

An exclude condition may be based on at least one of translation configuration information and exclude information that includes and/or otherwise identifies a reserved keyword. The keyword may be defined by and/or definable in at least one of a programming language of source code and a first representation language of a first translation of the source code. The keyword may be included in the translation configuration information and/or the exclude information for matching. An exclude condition may include and/or otherwise identify a matching criterion based on a keyword. A keyword may be an input for evaluating a matching condition. A keyword may be reserved by a language and/or may be specified based on information received from a user.

An exclude condition may be based on at least one of translation configuration information and exclude information that includes and/or otherwise identifies some or all of an identifier in an identifier space. The identifier space may be defined by and definable in at least one of a programming language of source code and/or a first representation language of a first translation of the source code. The identifier may be included in the translation configuration information and/or the exclude information for matching. An exclude condition may include and/or otherwise identify a matching criterion based on an identifier in an identifier space. An identifier in an identifier space may be an input for evaluating a matching condition.

As described above, a first representation language for translating to a second representation language, as well as the second representation language, may include assembler language, an object code language, a byte code language, a high-level programming language, and/or a machine code language. A representation language may include a machine code language and/or may include a language translatable into a machine code language.

The second translation may be a machine code translation. Translating the first translation to the second translation may include storing the machine code translation in a processor memory defined by an address space of an IPU for executing a machine code instruction in the machine code translation by the IPU.

A first translation of source code for translating into a second translation of the source code, as well as the second translation, may include an unresolved symbolic reference for resolving by a linking process, may be relocatable or not, may include position independent code (PIC) or not, and/or may have attributes of translations not generated according to the subject matter described herein.

A first translation may include a second addressable entity translated from source code specifying the second addressable entity in a programming language. The second addressable entity may include a reference to an excludable addressable entity. Excluding the excludable addressable entity from a second translation generated from the first translation may include excluding some or all of the second addressable entity from the second translation.

Alternatively or additionally, the first translation of the excludable addressable entity may include a reference to another addressable entity. Excluding the excludable addressable entity may include excluding some or all of the other addressable entity from the second translation. The other addressable entity may be included in another program component.

In a further aspect, an unresolved reference to an addressable entity in the second translation may be detected. The reference may be unresolved as a result of excluding the excludable addressable entity. The addressable entity for resolving the unresolved reference may be stored in a location in the processor memory identified by a referencing address to resolve the unresolved reference. That is, the referenced addressable entity may be stored in a location it would not have been stored in when the excludable addressable entity is not excluded from the second translation.

In an aspect, generating the second translation may include allocating an address space of an instruction-processing unit (IPU) in an execution environment to define a processor memory. The second translation may be stored in the processor memory by copying and/or mapping the second translation into the process memory. Storing the second translation may include storing a machine code instruction in the second translation in a location in the processor memory defined by an address in the address space. The IPU may be configured, for example by an instruction, to access the machine code instruction at the location, based on the address, and to execute the machine code instruction.

As has been described above, generating a second translation may include modifying an instruction and/or a data entity represented in the second translation in response to excluding an addressable entity. The instruction and/or data entity may be modified in the first translation prior to translating the modified instruction and/or data entity. The instruction and/or data entity may be modified in the second translation.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of a computer program in one or more of an electronic, magnetic, optical, electromagnetic, and infrared form, such that the instruction execution machine, system, apparatus, and/or device may read (or fetch) the instructions from the computer readable medium and execute the instructions for carrying out the described methods. A non-exhaustive list of conventional exemplary computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD.TM.), a Blu-ray.TM. disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for excluding an addressable entity from a translation of source code, the method comprising:
receiving a first translation, translated from source code including a first addressable entity specified in a programming language, including a first translation of the first addressable entity;
detecting excluding information identifying the first translation of the first addressable entity as excludable from a second translation, of the source code, translated from the first translation;
receiving translation configuration information for translating the first translation; and
translating, in response to receiving the translation configuration information, the first translation into the second translation excluding, based on the excluding information, the first addressable entity.

2. The method of claim 1 wherein the first addressable entity includes at least one of a variable, a constant, a function, a subroutine, a procedure, a module, a method, a class, an object, a scoped code block, and an instruction identified by a label according to the programming language.

3. The method of claim 1 wherein the excluding information is stored at least one of external to the first translation, in a data entity with the first translation, and in the first translation.

4. The method of claim 1 wherein at least a portion of the excluding information is stored in a symbol table based on the source code.

5. The method of claim 1 wherein the first translation is specified according to a first representation language that defines an identifier space of addressable entity identifiers and wherein a portion of the identifier space includes excludable addressable entity identifiers, including an identifier of the first addressable entity, according to the first representation language.

6. The method of claim 1 wherein the first translation is specified according to a first representation language that defines the first addressable entity as excludable in the absence of an indicator in the first translation that the first addressable entity is not excludable.

7. The method of claim 1 wherein the translation configuration information is at least one of received in and identified by the detected excluding information.

8. The method of claim 1 wherein translating the first translation into the second translation comprises:
identifying a location, in the first translation, including at least a portion of the first translation of the first addressable entity; and
not translating the at least a portion of the first translation of the first addressable entity.

9. The method of claim 1 wherein excluding the first addressable entity comprises:
determining that an exclude condition identified by the translation configuration information is met based on the excluding information; and
excluding the first addressable entity from the second translation, in response to determining that the exclude condition is met.

10. The method of claim 9 wherein the exclude condition is based on an attribute of the first addressable entity, wherein the attribute is at least one of defined by the programming language and specified by a user according to the programming language.

11. The method of claim 10 wherein the attribute at least one of includes and is included in at least one of a tag, a phrase, a symbol, a symbolic expression, a condition, a logical expression, a mathematical expression, and an annotation.

12. The method of claim 10 wherein the exclude condition at least one of includes and identifies a matching criterion based on the attribute.

13. The method of claim 1 wherein the second translation is specified according to a second representation language, wherein the second representation language at least one of is translatable into a machine code language and includes a machine code language.

14. The method of claim 1 further comprises:
detecting, in the first translation, a first translations of a second addressable entity including a reference to the excludable first addressable entity; and
excluding at least a portion of the second addressable entity from the second translation.

15. The method of claim 1 further comprises:
detecting, in the first translation of the first addressable entity, a reference to a second addressable entity; and
excluding at least a portion of the second addressable entity from the second translation.

16. The method of claim 1 wherein the translating comprises:
allocating an address space of an instruction-processing unit (IPU) to define a processor memory;
storing the second translation in the processor memory including storing a machine code instruction included in the second translation in a location defined by an address in the address space; and
configuring the IPU, based on the address, to access the machine code instruction at the location to execute the machine code instruction.

17. The method of claim 1 further comprises:
detecting an unresolved reference in the second translation, wherein the unresolved reference is a result of excluding the first addressable entity; and
resolving the unresolved reference.

18. The method of claim 1 further includes, in response to excluding the first addressable entity, modifying at least a portion of an addressable entity at least one of in the first translation prior to said translating and in the second translation.

19. A system for excluding an addressable entity from a translation of source code, the system comprising:
an execution environment including an instruction-processing unit configured to process an instruction included in at least one of a translation director component, an exclusion manager component, a configuration access component, and a translation engine component;
the translation director component configured for receiving a first translation, translated from source code including a first addressable entity specified in a programming language, including a first translation of the first addressable entity;
the exclusion manager component configured for detecting excluding information identifying the first translation of the first addressable entity as excludable from a second translation, of the source code, translated from the first translation;
the configuration access component configured for receiving translation configuration information for translating the first translation; and
the translation engine component configured for translating, in response to receiving the translation configuration information, the first translation into the second translation excluding, based on the excluding information, the first addressable entity.

20. A computer-readable medium embodying a computer program, executable by a machine, for excluding an addressable entity from a translation of source code, the computer program comprising executable instructions for:
receiving a first translation, translated from source code including a first addressable entity specified in a programming language, including a first translation of the first addressable entity;
detecting excluding information identifying the first translation of the first addressable entity as excludable from a second translation, of the source code, translated from the first translation;
receiving translation configuration information for translating the first translation; and
translating, in response to receiving the translation configuration information, the first translation into the second translation excluding, based on the excluding information, the first addressable entity.
